(19) United States
(12) Patent Application Publication
(10) Pub. No.: US 2008/0317264 A1
(43) Pub. Date: Dec. 25, 2008

(54) Device and Method for Capturing Vocal Sound and Mouth Region Images

(76) Inventor: Jordan Wynnychuk, Montreal (CA)

Correspondence Address: HOLLAND & KNIGHT LLP, 10 ST. JAMES AVENUE, 11th Floor, BOSTON, MA, 02116-3889, US

(21) Appl. No.: 12/158,445

(22) PCT Filed: Dec. 18, 2006
(86) PCT No.: PCT/CA2006/002055

§ 371 Date: Jun. 20, 2008

Related U.S. Application Data
(60) Provisional application No. 60/751,976, filed on Dec. 21, 2005.

(51) Int. Cl. H04R 25/00; G10L 11/00; G06K 9/00

(52) U.S. Cl. 381/150; 704/270; 382/115

(57) ABSTRACT

A device suitable for use in various applications, including, for example, sound production applications and video game applications. In one non-limiting embodiment, the device comprises a sound capturing unit for generating a first signal indicative of vocal sound produced by a user and an image capturing unit for generating a second signal indicative of images of a mouth region of the user. The device also comprises a processing unit communicatively coupled to the sound capturing unit and the image capturing unit for processing the first signal and the second signal. In an example in which the device is used for sound production, the processing unit is operative for processing the first signal and the second signal to cause a sound production unit to emit sound audibly perceivable as being a modified version of the vocal sound produced by the user. In an example in which the device is used for playing a video game, the processing unit is operative for processing the second signal to generate a video game feature control signal for controlling a feature associated with the video game. The feature associated with the video game may be a virtual character of the video game. The processing unit is further operative for processing the first signal for causing a sound production unit to emit sound associated with the video game.

### FIELD OF THE INVENTION

The present invention relates generally to a device and a method for capturing vocal sound and mouth region images and usable in various applications, including sound production applications and video game applications.

### BACKGROUND

The sensory and motor homunculi pictorially reflect proportions of sensory and motor areas of the human cerebral cortex associated with human body parts. A striking aspect of the motor homunculus is the relatively large proportion of motor areas of the cerebral cortex associated with body parts involved in verbal and nonverbal communication, namely the face and, in particular, the mouth region. That is, humans possess a great degree of motor control over the face and particularly over the mouth region.

The sensory and motor homunculi have been recognized as important considerations for human-machine interaction. Nevertheless, human-machine interaction utilizing human facial and particularly mouth region motor control remains a relatively unexplored concept that may still be applied to and benefit several fields of application. For example, the field of sound production, the field of video gaming, and various other fields may benefit from such human-machine interaction based on human facial and particularly mouth region motor control.

Thus, there is a need for improvements enabling utilization of human facial and particularly mouth region motor control for various types of applications, including, for example, sound production applications and video game applications.

### SUMMARY

According to a first broad aspect, the invention provides a device for use in sound production. The device comprises a sound capturing unit for generating a first signal indicative of vocal sound produced by a user. The device also comprises an image capturing unit for generating a second signal indicative of images of a mouth region of the user during production of the vocal sound. The device further comprises a processing unit communicatively coupled to the sound capturing unit and the image capturing unit. The processing unit is operative for processing the first signal and the second signal to cause a sound production unit to emit sound audibly perceivable as being a modified version of the vocal sound produced by the user.

According to a second broad aspect, the invention provides a computer-readable storage medium comprising a program element suitable for execution by a computing apparatus. The program element when executing on the computing apparatus is operative for:
receiving a first signal indicative of vocal sound produced by a user;
receiving a second signal indicative of images of a mouth region of the user during production of the vocal sound; and
processing the first signal and the second signal to cause a sound production unit to emit sound audibly perceivable as being a modified version of the vocal sound produced by the user.

According to a third broad aspect, the invention provides a method for use in sound production. The method comprises:
generating a first signal indicative of vocal sound produced by a user;
generating a second signal indicative of images of a mouth region of the user during production of the vocal sound; and
processing the first signal and the second signal to cause a sound production unit to emit sound audibly perceivable as being a modified version of the vocal sound produced by the user.

According to a fourth broad aspect, the invention provides a device suitable for use in playing a video game. The device comprises an image capturing unit for generating a first signal indicative of images of a mouth region of a user. The device also comprises a processing unit communicatively coupled to the image capturing unit. The processing unit is operative for processing the first signal to generate a video game feature control signal for controlling a feature associated with the video game.

According to a fifth broad aspect, the invention provides a computer-readable storage medium comprising a program element suitable for execution by a computing apparatus. The program element when executing on the computing apparatus is operative for:
receiving a first signal indicative of images of a mouth region of a user; and
processing the first signal to generate a video game feature control signal for controlling a feature associated with a video game playable by the user.

According to a sixth broad aspect, the invention provides a method for enabling a user to play a video game. The method comprises:
generating a first signal indicative of images of a mouth region of the user; and
processing the first signal to generate a video game feature control signal for controlling a feature associated with the video game.

According to a seventh broad aspect, the invention provides a device for capturing vocal sound and mouth region images. The device comprises a support structure defining an opening leading to a cavity, the opening being configured to be placed adjacent to a mouth region of a user during use. The device also comprises a sound capturing unit coupled to the support structure and located in the cavity. The sound capturing unit is operative for generating a first signal indicative of vocal sound produced by the user. The device further comprises an image capturing unit coupled to the support structure and located in the cavity. The image capturing unit is operative for generating a second signal indicative of images of the mouth region of the user.

These and other aspects and features of the invention will now become apparent to those of ordinary skill in the art upon review of the following description of specific embodiments of the invention in conjunction with the accompanying drawings.

### BRIEF DESCRIPTION OF THE DRAWINGS

A detailed description of certain embodiments of the invention is provided herein below, by way of example only, with reference to the accompanying drawings.

In the accompanying drawings:

FIG. 1 is a first diagrammatic perspective view of a device for capturing vocal sound produced by a user and images of a mouth region of the user during production of the vocal sound, in accordance with a non-limiting embodiment of the present invention;

FIG. 2 is a second diagrammatic perspective view of the device shown in FIG. 1, illustrating another side of the device;

FIG. 3 is a diagrammatic cross-sectional elevation view of the device shown in FIG. 1;

FIG. 4 is a third diagrammatic perspective view of the device shown in FIG. 1, illustrating a top portion of a support structure of the device;

FIG. 5 is a diagrammatic plan view of the device shown in FIG. 1, partly cross-sectioned to illustrate an image capturing unit of the device;

FIG. 6 is diagrammatic representation of the mouth region of the user;

FIG. 7 is a block diagram illustrating interaction between a processing unit of the device shown in FIG. 1 and a sound production unit, according to an example of application of the device wherein the device is used for sound production; and

FIG. 8 is a block diagram illustrating interaction between a processing unit of the device shown in FIG. 1, a display unit, and a sound production unit, according to an example of application of the device wherein the device is used for playing a video game.

It is to be expressly understood that the description and drawings are only for the purpose of illustration of certain embodiments of the invention and are an aid for understanding. They are not intended to be a definition of the limits of the invention.

### DETAILED DESCRIPTION OF EMBODIMENTS

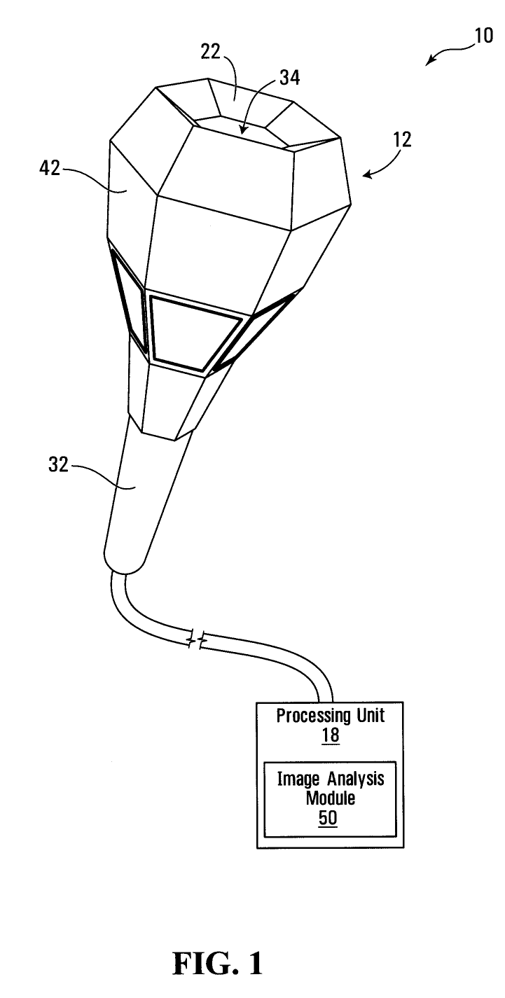

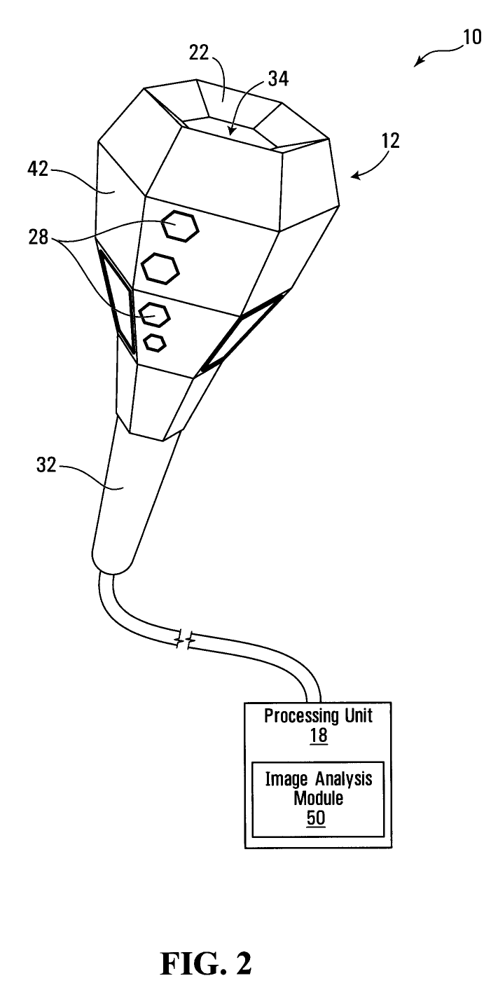

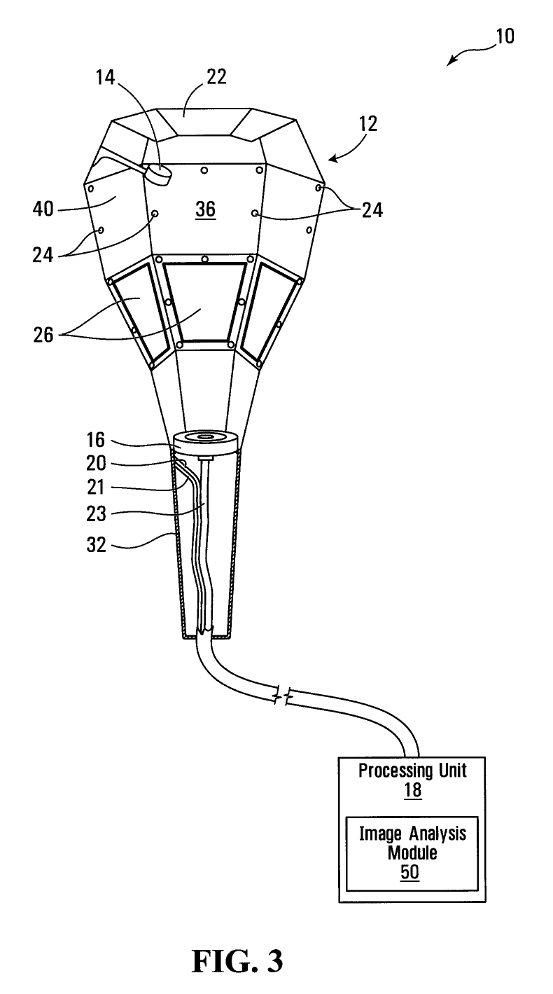

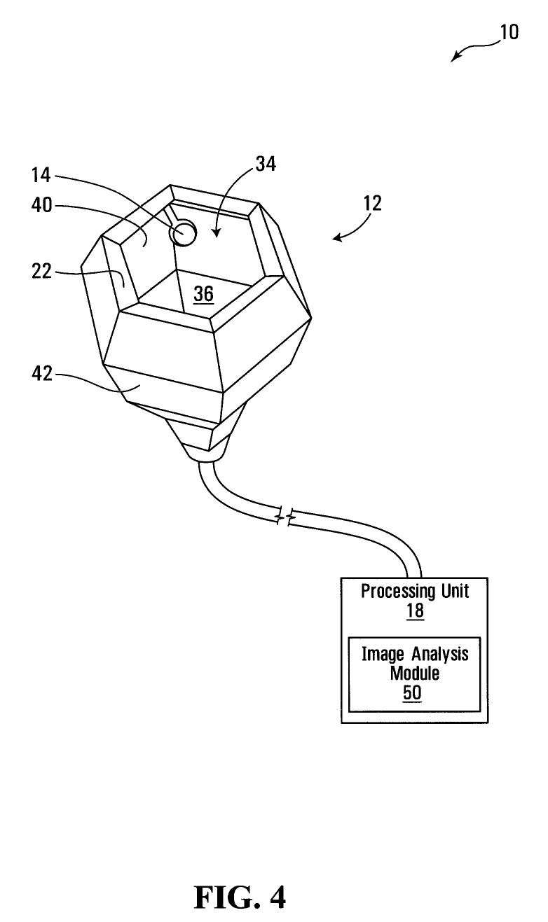

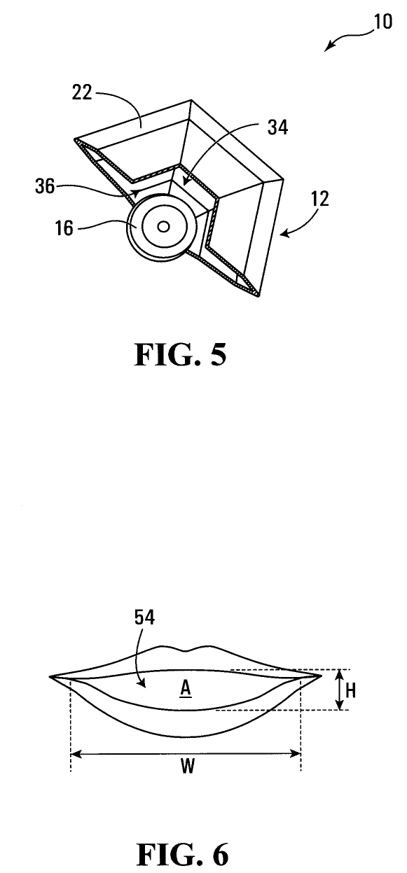

FIGS. 1 to 5 illustrate a device 10 in accordance with a non-limiting embodiment of the present invention. As described below, when used by a user, the device 10 is operative to capture vocal sound produced by the user and images of a mouth region of the user during production of the vocal sound. The device 10 and the captured vocal sound and mouth region images may be used in various applications. In one non-limiting example described in further detail below, the device 10 may be used in a sound production application such as a musical application (e.g. a musical recording or live performance application). In such an example, the device 10 uses the captured vocal sound and mouth region images to cause emission of sound by a sound production unit including a speaker. In another non-limiting example also described in further detail below, the device 10 may be used in a video game application. In such an example, the device 10 uses the captured vocal sound and mouth region images to cause control of aspects of a video game such as a virtual character of the video game and sound emitted by a speaker while the video game is being played.

With continued reference to FIGS. 1 to 5, in this non-limiting embodiment, the device 10 comprises a support structure 12 to which are coupled a sound capturing unit 14 and an image capturing unit 16. The support structure 12 also supports a mouthpiece 22, lighting elements 24, acoustic reflection inhibiting elements 26, and control elements 28. The device 10 further comprises a processing unit 18 communicatively coupled to the sound capturing unit 14, the image capturing unit 16, and the control elements 28. These components of the device 10 will now be described.

In this non-limiting example of implementation, the support structure 12 is configured as a handheld unit. That is, the support structure 12 is sized and shaped so as to allow it to be handheld and easily manipulated by the user. The support structure 12 also has a handle portion 32 adapted to be received in a stand so as to allow the support structure 12 to be stand-held, thereby allowing hands-free use by the user.

In this non-limiting embodiment, the support structure 12 defines an opening 34 leading to a cavity 36 in which are located the sound capturing unit 14 and the image capturing unit 16. The opening 34 is configured to be placed adjacent to the user's mouth and to allow the user's mouth to be freely opened and closed when the user uses the device 10. The cavity 36 is defined by an internal wall 40 of the support structure 12. The sound capturing unit 14 is coupled to the internal wall 40 at an upper portion of the cavity 36 so as to capture vocal sound produced by the user when using the device 10. The image capturing unit 16 is coupled to the support structure 12 adjacent to a bottom portion of the cavity 36 and is aligned with the opening 34 so as to capture images of the mouth region of the user during production of vocal sound captured by the sound capturing unit 14. The sound capturing unit 14 and the image capturing unit 16 are positioned relative to each other such that the sound capturing unit 14 does not obstruct the image capturing unit's view of the user's mouth region when using the device 10. Further detail regarding functionality and operation of the sound capturing unit 14 and the image capturing unit 16 will be provided below.

While FIGS. 1 to 5 illustrate a specific non-limiting configuration for the support structure 12, it will be appreciated that various other configurations for the support structure 12 are possible. For example, the opening 34 and the cavity 36 may have various other suitable configurations or may even be omitted in certain embodiments. As another example, rather than being configured as a handheld or stand-held unit, the support structure 12 may be configured as a head-mountable unit adapted to be coupled to the user's head, thereby allowing mobile and hand-free use. In such an example, the head-mountable unit may be provided with a mask that defines the opening 34 and the cavity 36.

Continuing with FIGS. 1 to 5, the sound capturing unit 14 is adapted to generate a signal indicative of sound sensed by the sound capturing unit 14. This signal is transmitted to the processing unit 18 via a link 20, which in this specific example is a cable. When the user places his or her mouth adjacent to the opening 34 of the support structure 12 and produces vocal sound by speaking, singing, or otherwise vocally producing sound, the signal generated by the sound capturing unit 14 and transmitted to the processing unit 18 is indicative of the vocal sound produced by the user. The processing unit 18 may use the received signal to cause emission of sound by a speaker, as described later on.

The sound capturing unit 14 includes a microphone and possibly other suitable sound processing components. Various types of microphone may be used to implement the sound capturing unit 14, including vocal microphones, directional microphones (e.g. cardioid, hypercardioid, bi-directional, etc.), omnidirectional microphones, condenser microphones, dynamic microphone, and any other types of microphone. Also, although in the particular embodiment shown in FIGS. 1 to 5 the sound capturing unit 14 includes a single microphone, in other embodiments, the sound capturing unit 14 may include two or more microphones.

The image capturing unit 16 is adapted to generate a signal indicative of images captured by the image capturing unit 16. This signal is transmitted to the processing unit 18 via a link 23, which in this specific example is a cable. When the user places his or her mouth adjacent to the opening 34 of the support structure 12 and produces vocal sound, the signal generated by the image capturing unit 16 and transmitted to the processing unit 18 is indicative of images of the user's mouth region during production of the vocal sound. The processing unit 18 may use the received signal indicative mouth region images for various applications, as described later on.

In one non-limiting embodiment, the image capturing unit 16 may include a digital video camera utilizing, for instance, charge-coupled device (CCD) or complementary metal-oxide semiconductor (CMOS) technology. Also, although in the particular embodiment shown in FIGS. 1 to 5 the image capturing unit 16 includes a single video camera, in other embodiments, the image capturing unit 16 may include two or more video cameras, for instance, to capture images of the user's mouth region from different perspectives.

With continued reference to FIGS. 1 to 5, in this non-limiting embodiment, the lighting elements 24 are provided on the internal wall 40 of the support structure 12 and are adapted to emit light inside the cavity 36 so as to produce a controlled lighting environment within the cavity 36. This controlled lighting environment enables the image capturing unit 16 to operate substantially independently of external lighting conditions when the user's mouth is placed adjacent to the opening 34. The lighting elements 24 may be implemented as high-emission light emitting diodes (LEDs), lightbulbs, or any other elements capable of emitting light.

In one non-limiting embodiment, the lighting elements 24 may be coupled to the image capturing unit 16 such that the image capturing unit 16 may send signals to the lighting elements 24 to control their brightness. The image capturing unit 16 may proceed to regulate brightness of the lighting elements 24 based on lighting conditions that it senses. For instance, when the image capturing unit 16 senses lighting conditions in the cavity 36 that are too dim for optimal image capture, it sends signals to the lighting elements 24 to increase their brightness until it senses lighting conditions that are optimal for image capture. Various techniques may be employed to detect when insufficient lighting conditions exist within the cavity 36. Such techniques are well known to those skilled in the art and as such need not be described in further detail herein.

The acoustic reflection inhibiting elements 26 are also provided on the internal wall 40 (or form part) of the support structure 12 and are adapted to dampen acoustic reflection within the cavity 36. This promotes the sound capturing unit 14 picking up vocal sound waves produced by the user and not reflections of these waves within the cavity 36. The acoustic reflection inhibiting elements 26 may be implemented as perforated metal panels, acoustic absorption foam members, or any other elements capable of inhibiting acoustic reflection within the cavity 36.

The mouthpiece 22 extends around the opening 34 and is adapted to comfortably engage the user's face and obstruct external view of the user's mouth region while allowing the user to freely open and close his or her mouth when using the device 10. More particularly, in this particular embodiment, the mouthpiece 22 is adapted to comfortably engage the user's skin between the user's upper-lip and the user's nose and to allow unobstructed movement of the user's lips (e.g. unobstructed opening and closing of the user's mouth) during use of the device 10. Generally, the mouthpiece 22 may be configured to completely obstruct external view of the user's mouth region when viewed from any perspective, or to partially obstruct external view of the user's mouth region depending on the viewing perspective (e.g., complete obstruction if directly facing the user and only partial obstruction if looking from a side of the user). The mouthpiece 22 may be an integral part of the support structure 12 or may be a separate component coupled thereto. The mouthpiece 22 may be made of rubber, plastic, foam, shape memory material, or any other suitable material providing a comfortable interface with the user's face.

Advantageously, the mouthpiece 22 engages the user's face so as to minimize external light entering into the cavity 36, thereby mitigating potential effects of such external light on performance of the image capturing unit 16. In addition, the mouthpiece 22 contributes to optimum mouth region image capturing by the image capturing unit 16 by serving as a reference point or datum for positioning the user's mouth region at a specific distance and angle to the image capturing unit 16. Furthermore, by obstructing external view of the user's mouth, the mouthpiece 22 enables the user to perform any desired mouth movements during use of the device 10 while preventing individuals from seeing these movements. Knowledge that others cannot see movement of his or her mouth may give to the user confidence to perform any desired mouth movements during use of the device 10, which may be particularly desirable in cases where the user using the device 10 may be the center of attraction for several individuals (e.g. in musical applications described later below).

Continuing with FIGS. 1 to 5, the control elements 28 are provided on an external surface 42 of the support structure 12 so as to be accessible to the user using the device 10. The control elements 28 may be implemented as buttons, sliders, knobs, or any other elements suitable for being manipulated by the user. When manipulated by the user, the control elements 28 generate signals that are transmitted to the processing unit 18 via respective links 21, which in this specific example are cables. These signals may be used by the processing unit 18 in various ways depending on particular applications of the device 10, as will be described below. Examples of functionality which may be provided by the control elements 28 irrespective of the particular application of the device 10 include control of activation of the sound capturing unit 14, the image capturing unit 16, and the lighting elements 26.

While in the non-limiting embodiment of FIGS. 1 to 5, the sound capturing unit 14, the image capturing unit 16, and the control elements 28 are coupled to the processing unit 18 via a wired link, in other embodiments, this connection may be effected via a wireless link or a combination of wired and wireless links. Also, in this non-limiting embodiment, the sound capturing unit 14, the image capturing unit 16, the lighting elements 24, and the control elements 28 may be powered via their connection with the processing unit 18 or via electrical connection to a power source (e.g. a power outlet or a battery).

In view of the foregoing, it will be appreciated that when the user places his or her mouth adjacent to the mouthpiece 22 of the support structure 12 and produces vocal sound, the processing unit 18 receives from the sound capturing unit 14 and the image capturing unit 16 signals indicative of the vocal sound produced by the user and of images of the user's mouth region during production of that sound. The processing unit 18 and its operation will now be described.

In one non-limiting embodiment, the processing unit 18 may be implemented as software executable by a computing apparatus (not shown) such as a personal computer (PC). Generally, the processing unit 18 may be implemented as software, firmware, hardware, control logic, or a combination thereof.

The processing unit 18 receives the signal generated by the sound capturing unit 14 and uses this signal to cause emission of sound by a speaker. The manner in which the processing unit 18 uses the signal generated by the sound capturing unit 14 depends on the particular application of the device 10 and will be described below.

The processing unit 18 also receives the signal indicative of mouth region images generated by the image capturing unit 16 and processes this signal in order to derive data indicative of characteristics of the user's mouth region during vocalization. To that end, the processing unit 18 implements an image analysis module 50 operative to derive the data indicative of characteristics of the user's mouth region on a basis of the signal generated by the image capturing unit 16. In one non-limiting embodiment, the image analysis module 50 may use color and/or intensity threshold-based techniques to derive the data indicative of characteristics of the user's mouth region. In other non-limiting embodiments, the image analysis module 50 may employ motion detection techniques, model training algorithms (i.e. learning techniques), statistical image analysis techniques, or any other techniques which may be used for image analysis. Such techniques are well known to those skilled in the art and as such need not be described in further detail herein.

As illustrated in FIG. 6, in one non-limiting example of implementation, the characteristics of the user's mouth region for which data may be derived by the image analysis module 50 include shape characteristics of an opening 54 defined by the user's lips during vocalization, such as the height H, the width W, and the area A of the opening 54. Various other shape characteristics of the opening 54, of the user's lips themselves, or generally of the user's mouth region may be considered. Non-limiting examples of such shape characteristics include the location or the curvature of the opening 54, the location or the curvature of the user's lips, relative distances between the user's lips, or any other conceivable characteristic regarding shape of the user's mouth region.

While in the above-described example the processing unit 18 derives data indicative of shape characteristics of the user's mouth region, the processing unit 18 may derive data indicative of various other characteristics of the user's mouth region. For instance, data indicative of motion characteristics of the user's mouth region may be considered. Non-limiting examples of such motion characteristics include the speed at which the user moves his or her lips, the speed at which the opening 54 changes shape, movements of the user's tongue, etc.

The processing unit 18 uses the derived data indicative of characteristics of the user's mouth region for different purposes depending on the particular application of the device 10. Similarly, as mentioned previously, the processing unit 18 also uses the signal generated by the sound capturing unit 14 in different manners depending on the particular application of the device 10.

Accordingly, two non-limiting examples of application of the device 10 will now be described to illustrate various manners in which the processing unit 18 uses the signal generated by the sound capturing unit 14 and the derived data indicative of characteristics of the user's mouth region. The first example relates to a sound production application, in this particular case, a musical application, while the second example relates to a video game application.

### Musical Application

In this non-limiting example, the device 10 is used for sound production in the context of a musical application such as a musical recording application, musical live performance application, or any other musically-related application. However, it will be appreciated that the device 10 may be used in various other applications where sound production is desired (e.g. sound effect production).

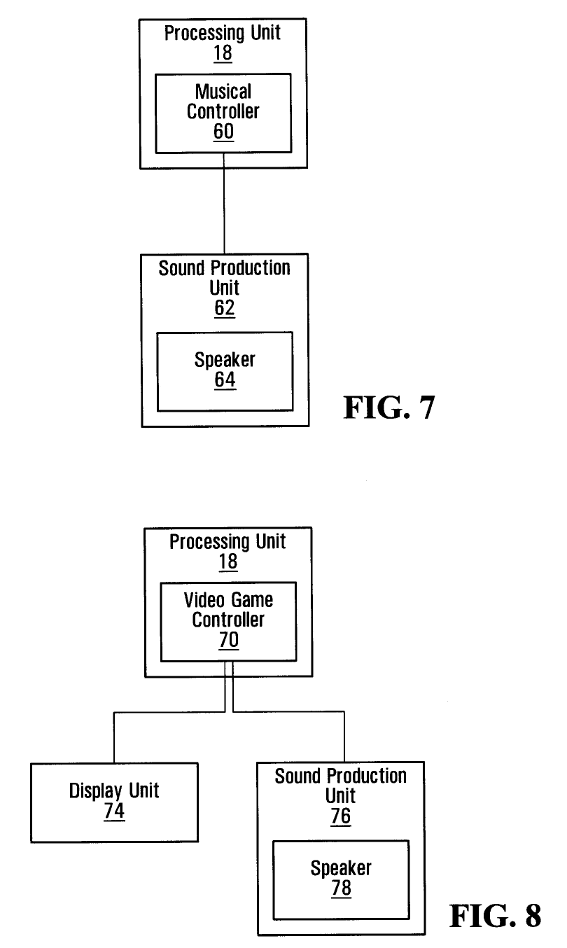

FIG. 7 depicts a non-limiting embodiment in which the processing unit 18 implements a musical controller 60. The musical controller 60 is coupled to a sound production unit 62, which includes at least one speaker 64 and potentially other components such as one or more amplifiers, filters, etc. Generally, the musical controller 60 may be implemented using software, firmware, hardware, control logic, or a combination thereof.

The musical controller 60 is operative to generate a sound control signal that is transmitted to the sound production unit 62 for causing emission of sound by the at least one speaker 64. Specifically, the processing unit 18 derives data regarding one or more sound control parameters on a basis of the derived data indicative of characteristics of the user's mouth region. Based on the data regarding the sound control parameters, the musical controller 60 generates the sound control signal and transmits this signal to the sound production unit 62.

The sound control signal is such that sound emitted by the sound production unit 62 is audibly perceivable as being different from the vocal sound produced by the user, captured by the sound capturing unit 14, and represented by the signal generated by the sound capturing unit 14. That is, someone hearing the sound emitted by the sound production unit 62 would perceive this sound as being an altered or modified version of the vocal sound produced by the user. In one non-limiting example of implementation, the musical controller 60 generates the sound control signal based on alteration of the signal generated by the sound capturing unit 14 in accordance with the derived data regarding the sound control parameters. The sound control signal is then released to the sound production unit 62 for causing emission of sound by the speaker 64, that sound being audibly perceivable as a modified version of the vocal sound produced by the user. In another non-limiting example of implementation, the sound control signal is a signal generated so as to control operation of the sound production unit 62, and the processing unit 18 transmits the signal generated by the sound capturing unit 14 to the sound production unit 62. In other words, in this non-limiting example, it can be said that two output signals are released by the processing unit 18 to the sound production unit 62, namely the sound control signal and the signal generated by the sound capturing unit 14. Upon receiving these two output signals, the sound production unit 62 is caused to emit a combination of audible sounds which together form sound that is effectively audibly perceivable as being a modified version of the vocal sound produced by the user.

Non-limiting examples of sound control parameters usable by the musical controller 60 include a volume control parameter, a volume sustain parameter, a volume damping parameter, a parameter indicative of a cut-off frequency of a sweeping resonant low-pass filter, and a parameter indicative of a resonance of a low-pass filter. Other non-limiting examples of sound control parameters include parameters relating to control of reverb, 3D spatialization, velocity, envelope, chorus, flanger, sample-and-hold, compressor, phase shifter, granulizer, tremolo, panpot, modulation, portamento, overdrive, effect level, channel level, etc. These examples are not to be considered limiting in any respect as various other suitable sound control parameters may be defined and used by the musical controller 60. In one non-limiting embodiment, the sound control parameters and the musical controller 60 may be based on a protocol such as the Musical Instrument Digital Interface (MIDI) protocol.

In a non-limiting example of implementation, each one of the sound control parameters is expressed as a function of one or more of the characteristics of the user's mouth region. That is, the processing unit 18 derives data regarding each one of the sound control parameters by inputting into a respective function the derived data indicative of one or more characteristics of the user's mouth region. For example, in a non-limiting embodiment in which the characteristics of the user's mouth region include the height H and the width W of an opening 54 defined by the user's lips during vocalization (see FIG. 6), the following functions may be used by the processing unit 18 in deriving data regarding some of the example sound control parameters mentioned above:
Volume control=ƒ₁(H);
Volume sustain=ƒ₂(H);
Volume damping=ƒ₃(H);
Cut-off frequency of a sweeping resonant low-pass filter=ƒ₄(H); and
Resonance of a low-pass filter=ƒ₅(g).

Those skilled in the art will appreciate that the particular form of each of the above example functions may be configured in any suitable manner depending on the application. Also, it is emphasized that the above example sound control parameters and their functional relationships with the example characteristics of the user's mouth region are presented for illustrative purposes only and are not to be considered limiting in any respect.

Furthermore, in the non-limiting embodiment shown in FIGS. 1 to 5 and 7, in addition to control of sound production via movement of the user's mouth region, one or more of the control elements 28 may be used by the user to effect further control over the sound emitted by the speaker 64. Specifically, one or more of the control elements 28 may provide control over one or more sound control parameters that are used by the musical controller 60 to generate the sound control signal. Thus, when the user manipulates the control elements 28, the processing unit 18 obtains data regarding one or more sound control parameters, which data is used by the musical controller 60 to generate the sound control signal for causing emission of sound by the speaker 64.

It will thus be appreciated that, when the user places his or her mouth adjacent to the opening 34 of the support structure 12 and produces vocal sound by speaking, singing, or otherwise vocally producing sound, the processing unit 18 receives from the sound capturing unit 14 and the image capturing unit 16 signals indicative of the vocal sound produced by the user and of images of the user's mouth region during production of that sound. The processing unit 18 processes the signal indicative of mouth region images in order to derive data indicative of characteristics of the mouth region during vocalization and, based on this, derives data regarding one or more sound control parameters. Optionally, the processing unit 18 may also obtain data regarding one or more sound control parameters as a result of interaction of the user with the control elements 28. The musical controller 60 then proceeds to generate the sound control signal in accordance with the data regarding the one or more sound control parameters. The sound control signal is transmitted to the sound production unit 62 for causing the latter to emit sound that is effectively perceivable as an altered or modified version of the vocal sound produced by the user. It will therefore be recognized that the device 10 enables the user to harness his or her degree of motor control over his or her mouth region to effect control over sound emitted by the sound production unit 62.

Although in the non-limiting embodiments described above the processing unit 18 uses both the signal generated by the sound capturing unit 14 and the signal generated by the image capturing unit 16 for causing emission of sound by the sound production unit 62, this is not to be considered limiting in any respect. In other non-limiting embodiments, the processing unit 18 may use only the signal generated by the image capturing unit 16 and not use the signal generated by the sound capturing unit 14 for causing emission of sound by the sound production unit 62. In such non-limiting embodiments, the sound capturing unit 14 may even be omitted from the device 10.

### Video Game Application

In this non-limiting example, the device 10 is used in the context of a video game application. In particular, the device 10 may be used for controlling aspects of a video game such as a virtual character of the video game as well as sounds associated with the video game.

FIG. 8 depicts a non-limiting embodiment in which the processing unit 18 implements a video game controller 70. The video game controller 70 is coupled to a display unit 74 (e.g. a television monitor or computer screen) and to a sound production unit 76, which includes at least one speaker 78 and potentially other components such as one or more amplifiers, filters, etc. Generally, the video game controller 70 may be implemented as software, firmware, hardware, control logic, or a combination thereof.

The video game controller 70 is operative to implement a video game playable by the user. As part of the video game, the video game controller 70 enables the user to control a virtual character that is displayed on the display unit 74. Specifically, the processing unit 18 derives data regarding one or more virtual character control parameters on a basis of the derived data indicative of characteristics of the user's mouth region. Based on the data regarding the virtual character control parameters, the video game controller 70 generates a virtual character control signal for controlling the virtual character displayed on the display unit 74.

The video game controller 70 also enables the user to control sound emitted by the at least one speaker 78 while the video game is being played, for instance, sound associated with the virtual character controlled by the user. Specifically, the video game controller 70 is operative to transmit a sound control signal to the sound production unit 76 for causing emission of sound by the at least one speaker 78. The sound control signal may be the signal generated by the sound capturing unit 14, in which case the sound emitted by the sound production unit 76 replicates the vocal sound produced by the user. Alternatively, the sound control signal may be generated on a basis of the signal generated by the sound capturing unit 14. For instance, the sound control signal may be a signal generated and sent to the sound production unit 76 so as to cause the latter to emit sound audibly perceivable as an altered version of the signal generated by the sound capturing unit 14, as described in the above musical application example.

In one non-limiting embodiment, the virtual character may have a virtual mouth region and the video game may involve the virtual character moving its virtual mouth region for performing certain actions such as speaking, singing, or otherwise vocally producing sound. When the user uses the device 10 to play the video game and moves his or her mouth region, the video game controller 70 controls the virtual character such that movement of its virtual mouth region mimics movement of the user's mouth region. That is, movement of the virtual character's virtual mouth region closely replicates movement of the user's mouth region. For example, the video game may be a singing or rapping video game, whereby the user may sing or rap while using the device 10 such that the virtual character is displayed on the display unit 74 singing or rapping as the user does and the speaker 78 emits a replica of the vocal sound produced by the user or an altered version thereof. As another example, the video game may include segments where the virtual character is required to speak (e.g. to another virtual character), in which case the user may use the device 10 to cause the display unit 74 to display the virtual character speaking as the user does and the speaker 78 to emit a replica of the vocal sound produced by the user or an altered version thereof.

It will be appreciated that the above examples of video games in which the device 10 may be used are presented for illustrative purposes only and are not to be considered limiting in any respect as the device 10 may be used with various other types of video games. For example, in some non-limiting embodiments of video games, rather than controlling speaking or singing actions performed by the virtual character, the virtual character's virtual mouth region may be controlled for firing virtual bullets, virtual lasers or other virtual projectiles, for breathing virtual fire, for emitting virtual sonic blasts, or for performing other actions so as to interact with the virtual character's environment, possibly including other virtual characters.

Also, while in the above examples a virtual mouth region of the virtual character is controlled by movement of the user's mouth region, it is to be understood that various other features associated with the virtual character may be controlled by movement of the user's mouth region. In fact, in some non-limiting embodiments, the virtual character may be devoid of a virtual mouth region and/or not even be of humanoid form. For instance, in some embodiments, the virtual character may be a vehicle, an animal, a robot, a piece of equipment, etc. Generally, the virtual character may be any conceivable object that may be controlled while playing the video game.

In a non-limiting example of implementation, each one of the virtual character control parameters is expressed as a function of one or more of the characteristics of the user's mouth region. That is, the processing unit 18 derives data regarding each one of the virtual character control parameters by inputting into a respective function the derived data indicative of one or more characteristics of the user's mouth region. For example, in a non-limiting embodiment wherein the characteristics of the user's mouth region include the height H and the width W of an opening 54 defined by the user's lips during vocalization (see FIG. 6) and wherein the video game involves movement of a virtual mouth region of the virtual character mimicking movement of the user's mouth region, the following functions may be used by the processing unit 18 in deriving data regarding the height Hᵥᵢᵣₜᵤₐₗ and the width Wᵥᵢᵣₜᵤₐₗ of an opening defined by the virtual character's virtual mouth region:
Hᵥᵢᵣₜᵤₐₗ=ƒ₁(H); and
W_{Virtual}=ƒ₂(W).

Those skilled in the art will appreciate that the particular form of each of the above example functions may be configured in any suitable manner depending on the application. Also, it is to be expressly understood that the above example virtual character control parameters and their functional relationships with the example characteristics of the user's mouth region are presented for illustrative purposes only and are not to be considered limiting in any respect as various other suitable virtual character control parameters may be defined and used by the video game controller 70.

Furthermore, in the non-limiting embodiment shown in FIGS. 1 to 5 and 8, in addition to control of the virtual character via movement of the user's mouth region, one or more of the control elements 28 may be used by the user to effect further control over how the video game is being played. For example, one or more of the control elements 28 may provide control over one or more virtual character control parameters that may be used by the video game controller 70 to generate the virtual character control signal. Thus, when the user manipulates the control elements 28, the processing unit 18 obtains data regarding one or more virtual character control parameters, which data is used by the video game controller 70 to cause display on the display unit 74 of the virtual character acting in a certain way. As another example, one or more of the control elements 28 may provide control over one or more sound control parameters that may be used by the video game controller 70 to generate the sound control signal transmitted to the sound production unit 76. As yet another example, one or more of the control elements 28 may enable the user to select game options during the course of the video game. In that sense, the control elements 28 can be viewed as providing joystick functionality to the device 10 for playing the video game.

It will thus be appreciated that, when the user plays the video game, places his or her mouth adjacent to the opening 34 of the support structure 12 and produces vocal sound by speaking, singing, or otherwise vocally producing sound, the processing unit 18 receives from the sound capturing unit 14 and the image capturing unit 16 signals indicative of the vocal sound produced by the user and of images of the user's mouth region during production of that sound. The processing unit 18 processes the signal indicative of mouth region images in order to derive data indicative of characteristics of the mouth region during vocalization and, based on this, derives data regarding one or more virtual character control parameters. Optionally, the processing unit 18 may also obtain data regarding one or more virtual character control parameters as a result of interaction of the user with the control elements 28. The video game controller 70 then proceeds to generate a virtual character control signal in accordance with the data regarding the one or more virtual character control parameters, thereby controlling the virtual character being displayed on the display unit 74. Simultaneously, the video game controller 70 may transmit a sound control signal to the sound production unit 76 for causing it to emit sound, in particular sound associated with the virtual character. It will therefore be recognized that the device 10 enables the user to control the virtual character while playing the video game based at least in part on utilization of the user's degree of mouth region motor control.

While in the above-described example of a video game application the device 10 enables control of a virtual character of the video game based on movement of the user's mouth region, this is not to be considered limiting in any respect. Generally, the device 10 may be used to control any feature associated with a video game based on movement of the user's mouth region. A virtual character is one type of feature that may be associated with a video game and controlled based on movement of the user's mouth region. In fact, sound associated with a video game is another type of feature that may be controlled based on movement of the user's mouth region. Thus, in some non-limiting embodiments, movement of the user's mouth region may be used to regulate sound control parameters that control sound emitted by the at least one speaker 78 (as described in the above musical example of application), in which case the signal generated by the sound capturing unit 16 may not be used and/or the sound capturing unit 16 may be omitted altogether. Other non-limiting examples of features that may be associated with a video game and controlled based on movement of the user's mouth region include: virtual lighting, visual effects, selection of options of the video game, text input into the video game, and any conceivable aspect of a video game that may be controlled based on user input.

Accordingly, while in the above-described example the processing unit 18 derives data regarding the virtual character control parameters and generates the virtual character control signal, this is not to be considered limiting in any respect. Generally, the processing unit 18 is operative to derive data regarding one or more video game feature control parameters on a basis of the derived data indicative of characteristics of the user's mouth region. Based on the data regarding the video game feature control parameters, the video game controller 70 generates a video game feature control signal for controlling a feature associated with the video game. It will thus be recognized that the virtual character control parameters and the virtual character control signal of the above-described example are respectively non-limiting examples of video game feature control parameters and video game feature control signal.

It will also be recognized that various modifications and enhancements to the above-described video game application example may be made. For example, in one non-limiting embodiment, the processing unit 18 may implement a speech recognition module for processing the signal generated by the sound capturing unit 14 and indicative of vocal sound produced by the user (and optionally the signal generated by the image capturing unit 16 and indicative of images of the user's mouth region during production of the vocal sound) such that spoken commands may be provided to the video game controller 70 by the user and used in the video game. These spoken commands once detected by the speech recognition module may result in certain events occurring in the video game (e.g. a virtual character uttering a command, query, response or other suitable utterance indicative of a certain action to be performed by an element of the virtual character's environment (e.g. another virtual character) or of a selection or decision made by the virtual character). As another example, in one non-limiting embodiment, the video game played by the user using the device 10 may simultaneously be played by other users using respective devices similar to the device 10. In such an embodiment, all of the users may be located in a common location with all the devices including the device 10 being connected to a common processing unit 18. Alternatively, the users may be remote from each other and play the video game over a network such as the Internet.

In view of the above-presented examples of application, it will be appreciated that the device 10 may be used in sound production applications (e.g. musical applications) and in video game applications. However, these examples are not to be considered limiting in any respect as the device 10 may be used in various other applications. For example, the device 10 may be used in applications related to control of a video hardware device (e.g. video mixing with controller input), control of video software (e.g. live-video and post-production applications), control of interactive lighting displays, control of a vehicle, control of construction or manufacturing equipment, and in various other applications.

Those skilled in the art will appreciate that in some embodiments, certain portions of the processing unit 18 may be implemented as pre-programmed hardware or firmware elements (e.g., application specific integrated circuits (ASICs), electrically erasable programmable read-only memories (EEPROMs), etc.), or other related components. In other embodiments, certain portions of the processing unit 18 may be implemented as an arithmetic and logic unit (ALU) having access to a code memory (not shown) which stores program instructions for the operation of the ALU. The program instructions may be stored on a medium which is fixed, tangible and readable directly by the processing unit 18 (e.g., removable diskette, CD-ROM, ROM, or fixed disk), or the program instructions may be stored remotely but transmittable to the processing unit 18 via a modem or other interface device (e.g., a communications adapter) connected to a network over a transmission medium. The transmission medium may be either a tangible medium (e.g., optical or analog communications lines) or a medium implemented using wireless techniques (e.g., microwave, infrared or other transmission schemes).

Although various embodiments have been illustrated, this was for the purpose of describing, but not limiting, the invention. Various modifications will become apparent to those skilled in the art and are within the scope of the present invention, which is defined by the attached claims.

1. A device for use in sound production, said device comprising:
a sound capturing unit for generating a first signal indicative of vocal sound produced by a user;
an image capturing unit for generating a second signal indicative of images of a mouth region of the user during production of the vocal sound; and
a processing unit communicatively coupled to said sound capturing unit and said image capturing unit, said processing unit being operative for processing the first signal and the second signal to cause a sound production unit to emit sound audibly perceivable as being a modified version of the vocal sound produced by the user.

2. A device as claimed in claim 1, wherein said processing unit is operative for:
processing the second signal to derive data indicative of at least one characteristic of the mouth region of the user during production of the vocal sound;
deriving data regarding at least one sound control parameter based at least in part on the data indicative of the at least one characteristic of the mouth region of the user during production of the vocal sound;
generating a sound control signal based at least in part on the data regarding the at least one sound control parameter; and
releasing the sound control signal to the sound production unit to cause emission of the sound audibly perceivable as being a modified version of the vocal sound produced by the user.

3. A device as claimed in claim 2, wherein said processing unit is operative for generating the sound control signal by altering the first signal in accordance with the data regarding the at least one sound control parameter.

4. A device as claimed in claim 2, wherein said processing unit is operative for releasing the first signal to the sound production unit along with the sound control signal so as to cause emission of the sound audibly perceivable as being a modified version of the vocal sound produced by the user.

5. A device as claimed in claim 2, wherein the at least one characteristic of the mouth region includes at least one shape characteristic of the mouth region.

6. A device as claimed in claim 5, wherein the mouth region of the user defines a mouth opening having a height, a width and an area, and wherein the at least one shape characteristic of the mouth region includes at least one of the height, the width and the area of the mouth opening.

7. A device as claimed in claim 2, wherein the at least one sound control parameter includes at least one Musical Instrument Digital Interface (MIDI) parameter.

8. A device as claimed in claim 2, wherein the at least one sound control parameter includes at least one of: a volume control parameter, a volume sustain parameter, a volume damping parameter, a parameter indicative of a cut-off frequency of a filter, a parameter indicative of a resonance of a filter, a reverb-related parameter, a 3D spatialization-related parameter, a velocity-related parameter, an envelope-related parameter, a chorus-related parameter, a flanger-related parameter, a sample-and-hold-related parameter, a compressor-related parameter, a phase shifter-related parameter, a granulizer-related parameter, a tremolo-related parameter, a panpot-related parameter, a modulation-related parameter, a portamento-related parameter, and an overdrive-related parameter.

9. A device as claimed in claim 1, wherein said sound capturing unit includes at least one microphone.

10. A device as claimed in claim 1, wherein said image capturing unit includes at least one digital video camera.

11. A device as claimed in claim 1, further comprising a support structure, said sound capturing unit and said image capturing unit being coupled to said support structure.

12. A device as claimed in claim 11, wherein said support structure is configured as a hand-held unit.

13. A device as claimed in claim 11, wherein said support structure has a portion enabling said support structure to be stand-held.

14. A device as claimed in claim 11, wherein said support structure defines an opening leading to a cavity, said sound capturing unit and said image capturing unit being located in said cavity.

15. A device as claimed in claim 14, wherein said opening is configured to be placed adjacent to the mouth region of the user during use.

16. A device as claimed in claim 14, further comprising at least one lighting element coupled to said support structure and operative for emitting light inside said cavity.

17. A device as claimed in claim 16, wherein at least one of said at least one lighting element is a light emitting diode.

18. A device as claimed in claim 14, wherein said support structure is provided with at least one acoustic reflection inhibiting element for inhibiting reflection of sound waves within said cavity.

19. A device as claimed in claim 18, wherein at least one of said at least one acoustic reflection inhibiting element includes one of a perforated panel and an acoustic absorption foam member.

20. A device as claimed in claim 15, wherein said support structure is provided with a mouthpiece adjacent to said opening, said mouthpiece being configured to obstruct external view of the mouth region of the user during use.

21. A device as claimed in claim 11, further comprising at least one control element coupled to said support structure and adapted to be manipulated by the user, each of said at least one control element being responsive to being manipulated by the user to generate a third signal for transmission to said processing unit.

22. A device as claimed in claim 21, wherein said processing unit is operative for:
processing the second signal to derive data indicative of at least one characteristic of the mouth region of the user during production of the vocal sound;
deriving data regarding at least one first sound control parameter based at least in part on the data indicative of the at least one characteristic of the mouth region of the user during production of the vocal sound;
processing the third signal to derive data regarding at least one second sound control parameter;
generating a sound control signal based at least in part on the data regarding the at least one first sound control parameter and the data regarding the at least one second sound control parameter; and
releasing the sound control signal to the sound production unit to cause emission of the sound audibly perceivable as being a modified version of the vocal sound produced by the user.

23. A computer-readable storage medium comprising a program element suitable for execution by a computing apparatus, said program element comprising:
first program instructions for causing the computing apparatus to receive a first signal indicative of vocal sound produced by a user;
second program instructions for causing the computing apparatus to receive a second signal indicative of images of a mouth region of the user during production of the vocal sound; and
third program instructions for causing the computing apparatus to process the first signal and the second signal to cause a sound production unit to emit sound audibly perceivable as being a modified version of the vocal sound produced by the user.

24. A computer-readable storage medium as claimed in claim 23, wherein said third program instructions are for causing the computing apparatus to:
process the second signal to derive data indicative of at least one characteristic of the mouth region of the user during production of the vocal sound;
derive data regarding at least one sound control parameter based at least in part on the data indicative of the at least one characteristic of the mouth region of the user during production of the vocal sound;
generate a sound control signal based at least in part on the data regarding the at least one sound control parameter; and
release the sound control signal to the sound production unit to cause emission of the sound audibly perceivable as being a modified version of the vocal sound produced by the user.

25. A computer-readable storage medium as claimed in claim 24, wherein said third program instructions are for causing the computing apparatus to generate the sound control signal by altering the first signal in accordance with the data regarding the at least one sound control parameter.

26. A computer-readable storage medium as claimed in claim 24, wherein said third program instructions are for causing the computing apparatus to release the first signal to the sound production unit along with the sound control signal so as to cause emission of the sound audibly perceivable as being a modified version of the vocal sound produced by the user.

27. A method for use in sound production, said method comprising:
generating a first signal indicative of vocal sound produced by a user;
generating a second signal indicative of images of a mouth region of the user during production of the vocal sound; and
processing the first signal and the second signal to cause a sound production unit to emit sound audibly perceivable as being a modified version of the vocal sound produced by the user.

28. A method as claimed in claim 27, wherein said processing comprises:
processing the second signal to derive data indicative of at least one characteristic of the mouth region of the user during production of the vocal sound;
deriving data regarding at least one sound control parameter based at least in part on the data indicative of the at least one characteristic of the mouth region of the user during production of the vocal sound;
generating a sound control signal based at least in part on the data regarding the at least one sound control parameter; and
releasing the sound control signal to the sound production unit to cause emission of the sound audibly perceivable as being a modified version of the vocal sound produced by the user.

29. A method as claimed in claim 28, wherein generating the sound control signal comprises altering the first signal in accordance with the data regarding the at least one sound control parameter.

30. A method as claimed in claim 28, further comprising releasing the first signal to the sound production unit along with the sound control signal so as to cause emission of the sound audibly perceivable as being a modified version of the vocal sound produced by the user.

31.-86. (canceled)
